(19) United States
(12) Patent Application Publication
(10) Pub. No.: US 2010/0037975 A1
(43) Pub. Date: Feb. 18, 2010

(54) PIPING APPARATUS AND MODULAR SYSTEM FOR THE CONSTRUCTION OF A PIPING APPARATUS

(76) Inventor: Rolf ZOELLER, Brackenheim (DE)

Correspondence Address: HARNESS, DICKEY & PIERCE, P.L.C., P.O. BOX 828, BLOOMFIELD HILLS, MI, 48303, US

(21) Appl. No.: 12/542,005

(22) Filed: Aug. 17, 2009

Related U.S. Application Data
(63) Continuation of application No. PCT/EP2008/001225, filed on Feb. 18, 2008.

(30) Foreign Application Priority Data
Feb. 20, 2007 (DE) 10 2007 008 644.1

(51) Int. Cl. F16L 9/00

(52) U.S. Cl. 138/155; 138/109; 285/133.11; 285/179; 285/399

(57) ABSTRACT

The invention relates to a piping apparatus for carrying a cooling or lubricating medium in a transmission or an engine, preferably in a vehicle, with a pipe for carrying a medium and at least one outlet opening for conducting the medium out of the pipe. It is distinguished by virtue of the fact that the piping comprises multiple standardized piping elements (12), that at least one piping element (12) is a piping element having an outlet opening (14), and that the piping elements (12) are made from a plastic. The invention further relates to a modular system for the construction of such a piping apparatus.

### CROSSREFERENCES TO RELATED APPLICATIONS

This application is a continuation of copending international patent application PCT/EP2008/001225 filed on Feb. 18, 2008 and designating U.S., which was published in the German language and claims priority of German patent application DE 10 2007 008 644.1 filed on Feb. 20, 2007. The entire contents of these applications are incorporated herein by reference.

### BACKGROUND OF THE INVENTION

The present invention relates to a piping apparatus for carrying a cooling or lubricating medium in a transmission or an engine, preferably in a vehicle, with a pipe for carrying a medium and at least one outlet opening for conducting the medium out of the pipe. The invention further relates to a modular system for the construction of such a piping apparatus.

Piping apparatuses of the aforementioned type are common knowledge. They are used in transmissions with dry sump lubrication, for example. DE 10 2005 005 154 A1, for example, shows such a transmission. A general distinguishing feature of transmissions with dry sump lubrication is that the transmission gears are not immersed in the transmission oil filling the bottom area of the transmission casing. The gears, bearings etc. are lubricated by a separate lubricating oil circuit. Provision is usually made in the transmission casing for a transmission oil pump, which draws the transmission oil out of the oil sump and delivers it to spray nozzles or oiling bores, which serve to oil the gear wheels, bearings etc. For carrying the transmission oil to the spray nozzles or oiling bores a piping apparatus, which via corresponding pipe sections carries the oil to the required locations, is provided inside the transmission casing.

The increasing complexity of modern transmissions, especially of dual clutch transmissions, also increases the complexity of the piping apparatus, since the transmission oil has to be carried to many more points inside the transmission casing. In the case of dual clutch transmissions, in particular, the number of gears to be lubricated is significantly greater than in conventional transmissions.

The piping apparatuses hitherto used are made of metal and in each case adapted to the respective transmission type, by bending metal pipes to fit, for example.

Since cost pressures are very great, especially in the automobile industry, there is a desire to create more cost-effective systems, which will afford cost advantages both in manufacturing and in installation during the production process.

### SUMMARY OF THE INVENTION

Against this background, the object of the present invention is to develop a piping apparatus of the aforementioned type so as to reduce manufacturing costs and to facilitate installation.

This object is achieved in the case of the aforementioned piping apparatus in that the piping comprises multiple standardized piping elements, that at least one piping element is a piping element having an outlet opening and that the piping elements are made from a plastic.

That is to say, in other words, that the piping apparatus is not, as hitherto, constructed from one or a few piping elements adapted to the particular application but that the piping apparatus comprises a plurality of standardized piping elements in the geometry specifically required. The piping elements are standardized in respect of their connection areas, so that any piping element can be fitted into any other piping element. The actual piping elements are likewise standardized, that is to say there are, for example, straight piping elements of different length, angle piping elements with different angles, terminating piping elements and piping elements with outlet openings and T-piping elements.

The advantage lies in the fact that any piping geometries required can be constructed using the standardized piping elements. This means that in manufacturing the tools for producing the piping elements can be used for longer, even if a piping geometry is modified. This leads to significant cost savings.

In addition it is possible to supply the piping apparatus constructed from individual piping elements in two or more sub-sections, and to undertake final assembly only when inserting it into the transmission. Depending on the geometry of the transmission casing, this can facilitate installation considerably.

A further advantage of the piping apparatus according to the invention is that the piping elements are made from plastic. The plastic used not only has weight advantages but is also more cost-effective, so that the piping apparatus as a whole affords a significant cost advantage.

Compared to metal, plastics are moreover easier to process, so that even complicated geometries of the individual piping elements are easy to produce.

In a preferred development the plastic used is polyamide.

This measure has the advantage that polyamide is very well-suited to environments with large temperature differences. This is particularly important for use in transmission casings, where the temperature fluctuations can be very large.

Various solutions are feasible for connecting two piping elements, the use of a socket connection being especially preferred. In order to allow such socket connections, each piping element has a male and a female section, so that the piping elements can be freely connected to one another. The connection is preferably secured by locking elements, which may be provided either outside or inside the piping elements.

The male and female connecting sections furthermore preferably have tooth systems, which fit together and provide a safeguard against torsion.

Other possible connections between piping elements are obviously also feasible, for example ultrasonic welding or adhesive bonding.

The object of the invention is also achieved by a modular system for the construction of a piping apparatus, as previously described. The modular system comprises multiple straight piping elements of different length, multiple angle piping elements having various bends, at least one piping element having an outlet opening, at least one connection piping element and at least one end piping element, which terminates the piping apparatus in a longitudinal direction, the piping elements at their ends having connecting sections, which are standardized and are designed in such a way that any piping elements desired can be fitted into one another and connected together, and the piping elements being made from a plastic.

The modular system makes it possible to construct piping apparatuses of widely varying geometry without the need to produce a specially tailored piping apparatus. There are various advantages to such a modular system and these have already been described previously.

One major advantage is that the individual standardized piping elements can be produced in large quantities, without being matched to any existing geometry. Instead they may be used to construct widely varying piping geometries.

Further advantages and embodiments of the invention are set forth in the description and the drawing attached.

It goes without saying that the features specified above and yet to be explained below can be used not only in the respective combination specified, but also in other combinations or alone, without departing from the scope of the present invention.

### BRIEF DESCRIPTION OF THE DRAWINGS

The invention will now be explained in more detail on the basis of an exemplary embodiment and with reference to the drawings, in which:

FIG. 1 shows a schematic representation of a piping apparatus according to the invention with corresponding designation of the individual piping elements;

FIG. 2 shows a schematic representation of the piping apparatus in FIG. 1 in another perspective view;

FIGS. 3a, b shows a piping element having toothed end sections;

FIG. 4 shows a schematic representation of two piping elements connected together;

FIG. 5 shows a perspective view of a piping element having an outlet opening; and

FIG. 6 shows a sectional representation of two piping elements connected together.

### DETAILED DESCRIPTION OF PREFERRED EMBODIMENTS

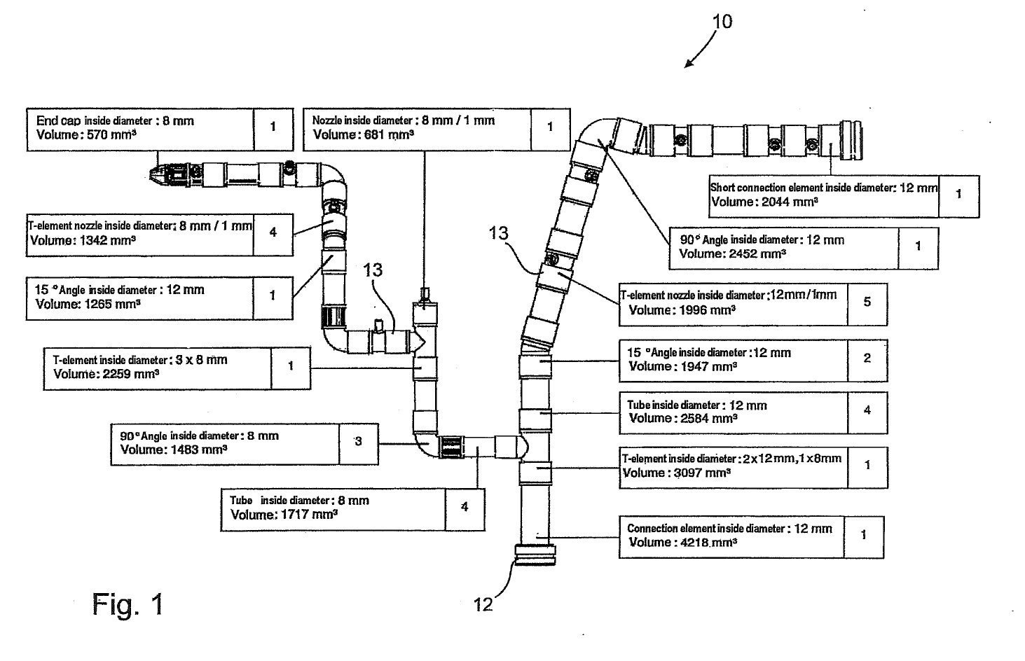

FIG. 1 shows a schematic representation of a piping apparatus according to the invention identified by the reference numeral 10. The piping apparatus 10 shown has a specific geometry, which serves purely as an example, however. It goes without saying that the piping apparatus 10 may have any geometry. The geometry is selected solely according to the particular application.

The piping apparatus 10 is used in a transmission casing in order to deliver oil from an oil reservoir to the required locations. The piping apparatus 10 can naturally also be used for other purposes, however.

The piping apparatus 10 is assembled from a plurality of different piping elements, which in FIG. 1 are each labeled with their name, diameter and volume. In addition, the label also specifies in the second column how often this type of piping element is fitted in the piping apparatus 10. Thus the piping element identified by the reference numeral 13, for example, which takes the form of T-element with nozzle, occurs a total of five times in the piping apparatus 10.

From the representation in FIG. 1 it can be seen that in addition to straight tubular piping elements there are angle piping elements, T-piping elements, connection piping elements, end cap piping elements, as well as nozzle and T-nozzle piping elements. From these basic types of piping it is possible to construct widely varying geometries of a piping apparatus 10.

The actual piping elements are made from a plastic, in particular polyamide, for example by an injection molding method. It is obviously feasible to make the piping elements 12 from some other material, but plastic, in particular polyamide, is advantageous from a cost standpoint.

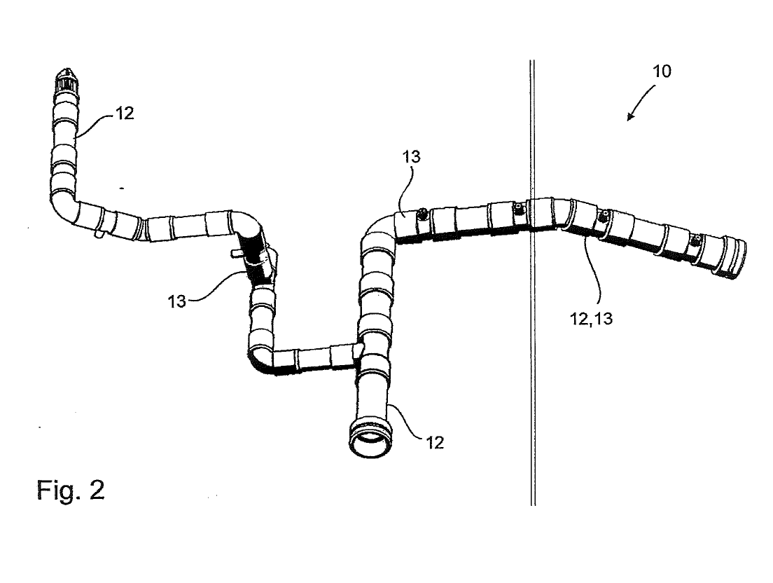

FIG. 2 again represents the piping apparatus 10 in FIG. 1 from a different perspective. Clearly visible are the T-nozzle piping elements 13, which each have a lateral outlet opening. The medium carried by the piping apparatus 10, namely a transmission oil, for example, can be delivered to a specific location via this outlet opening.

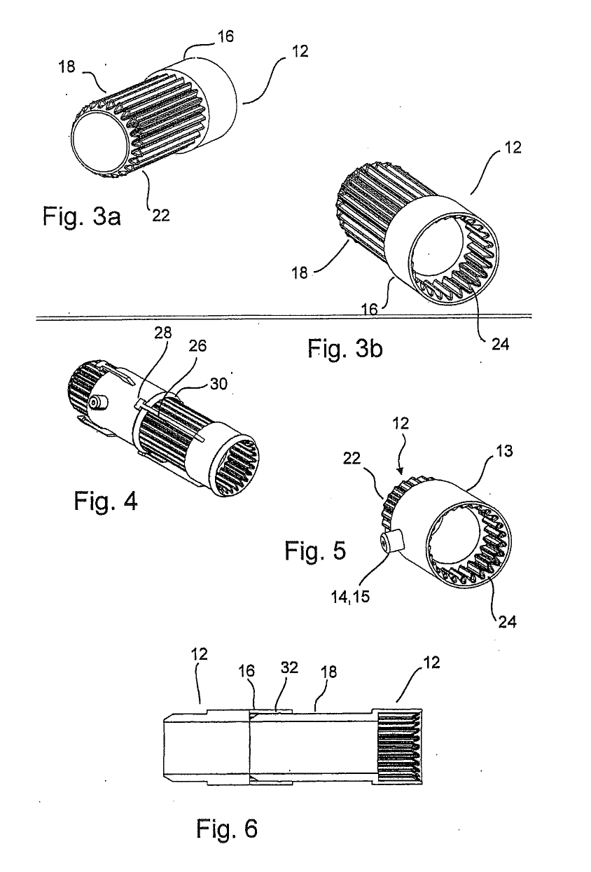

The individual piping elements are connected by fitting them into one another, each piping element having a male and a female end section for this purpose. This will be explained briefly below with reference to FIGS. 3a and 3b.

The piping element 12 shown in FIG. 3a has a first end section 16, which serves as female section, and a second end section 18, which serves as male end section. The inside diameter of the female end section here corresponds to the outside diameter of the male end section 18. This configuration of the respective ends of each piping element 12 is standardized, that is to say it is of the same design on all the different piping elements. This ensures that different piping elements can be connected to one another as required.

In order to afford a safeguard against torsion between two connected piping elements 12, that is to say two elements fitted into one another, the two end sections 16, 18 have a tooth system. Thus the female end section 16 has an internal tooth system 24 and the male end section 18 has an external tooth system 22. If two piping elements 12 are now fitted into one another, the internal and external tooth systems interact, ensuring that the two piping elements 12 can no longer rotate relative to one another.

Other solutions are naturally also feasible in order to safeguard against torsion. In the simplest case two piping elements fitted into one another without a tooth system are adhesively bonded together or joined by ultrasonic welding, for example.

In order to prevent two piping elements 12 fitted into one another becoming detached from one another again, locking elements are provided, for example, which in the fitted state interlock and thus secure the piping elements 12 in a longitudinal direction.

FIG. 4, for example, shows a schematic representation of one possible locking mechanism. The locking mechanism here comprises multiple arms 26, which extend on the outside of a piping element 12 along the male end section 18 to the end, and at their end have a locking element 28. This locking element 28 is flexible in a radial direction and when the piping element is fitted into another piping element can therefore slide over an edge 30 of the other piping element and latch behind it against a corresponding step. This type of locking mechanism serves to secure the piping element against detachment from the other piping element. The number of arms 26 uniformly spaced in a circumferential direction depends on the purpose of the particular application, three or four arms 26 with corresponding locking elements 28 generally being sufficient to ensure a secure connection.

Another type of locking mechanism is represented schematically in FIG. 6. In this solution the male end section 18 of a piping element 12 has one or more lugs 32, which extend in a radial direction and which are capable of interacting with corresponding depressions provided in the female end section 16 of the other piping element 12. If the piping element 12 is fitted into the other piping element 12, the lugs 32 latch in the depressions when the piping element 12 is in a specific longitudinal position, thereby holding the two interconnected piping elements together.

Other locking mechanisms are naturally also feasible.

FIG. 5 finally represents a single piping element 12, which has an outlet opening 14, which extends in a radial direction. By virtue of its geometry the outlet opening 14 is designed as a nozzle 15. A proportion of the medium carried in the piping element 12 can pass out through this nozzle 15.

This nozzle piping element 13, too, has the two end sections 16 and 18 already mentioned, with an external tooth system 22 and an internal tooth system 24, so as to thereby rotationally lock the nozzle piping element 13 to an adjacent piping element 12. This torsionally secured connection ensures that the nozzle 15 points in precisely the required direction.

Since the torsionally secured connection between two piping elements 12 is not important for every piping element, individual types of piping element may also be designed without a tooth system.

The fact that the piping elements 12 are standardized in respect of their end sections for connection to one another, means that the modular system can be constructed from various types of piping elements. This modular system may comprise straight tubular piping elements of different length, angle piping elements with differently graduated angles, for example 15°, 45°, 90°, end cap piping elements for the termination of pipes, as well as T-piping elements and nozzle piping elements. From this basic set of different piping elements it is possible to construct virtually any piping geometry 10, so that no machines, adapted for the respective application, are required for bending pipes etc. The modular system consequently not only facilitates rapid prototyping, but also saves costs, since the tooling for the individual piping elements can be used for widely varying piping geometries.

What is claimed is:

1. A piping apparatus for carrying a cooling or lubricating medium in a transmission or an engine, preferably in a vehicle, with a pipe for carrying a medium and at least one outlet opening for conducting the medium out of the pipe, wherein
the piping comprises multiple standardized piping elements,
at least one piping element is a piping element having an outlet opening, and
the piping elements are made from a plastic.

2. The piping apparatus as claimed in claim 1, wherein the plastic is polyamide.

3. The piping apparatus as claimed in claim 1, wherein at least one piping element is embodied as a T-element.

4. The piping apparatus as claimed in claim 1, wherein at least one piping element is embodied as an angle element.

5. The piping apparatus as claimed in claim 1, wherein at least one piping element is embodied as a straight tubular element.

6. The piping apparatus as claimed in claim 1, wherein at least one piping element is embodied as connection element.

7. The piping apparatus as claimed in claim 1, wherein each piping element has a first longitudinal section for fitting into an adjacent piping element and a second longitudinal section for receiving a section of an adjacent piping element.

8. The piping apparatus as claimed in claim 7, wherein the two longitudinal sections have a tooth system, in order to afford a safeguard against torsion when fitting two piping elements together.

9. The piping apparatus as claimed in claim 7, wherein adjacent piping elements are connected together by welding, in particular ultrasonic welding.

10. The piping apparatus as claimed in claim 7, wherein adjacent piping elements are adhesively bonded together.

11. The piping apparatus as claimed in claim 1, wherein
at least one piping element is embodied as an element selected from the group comprising a T-element, an angle element, a straight tubular element and a connection element; and
wherein each piping element has a first longitudinal section for fitting into an adjacent piping element and a second longitudinal section for receiving a section of an adjacent piping element.

12. A modular system for the construction of a piping apparatus for injection lubrication, comprising:
multiple straight piping elements of different length,
multiple angle piping elements having various bends,
at least one piping element having an outlet opening,
at least one connection piping element, and
at least one end piping element, which terminates the piping apparatus in a longitudinal direction,
wherein the piping elements at their ends have connecting sections, which are standardized and are designed in such a way that any of the piping elements can be fitted into one another and connected together, and further wherein the piping elements are made from a plastic.
